(19) United States
(12) Patent Application Publication
(10) Pub. No.: US 2011/0052930 A1
(43) Pub. Date: Mar. 3, 2011

(54) High Gloss Thermoformed Article and Process for Producing Same

(76) Inventors: Jinder Jow, Missouri City, TX (US); Michael S. Broadway, Clute, TX (US); Malcolm F. Finlayson, Houston, TX (US); Todd A. Hogan, Sanford, MI (US); Drew A. Davidock, Randolph, NJ (US); Angel S. Mendez, Saginaw, MI (US)

(21) Appl. No.: 12/861,146

(22) Filed: Aug. 23, 2010

Related U.S. Application Data
(60) Provisional application No. 61/237,747, filed on Aug. 28, 2009.

(51) Int. Cl. B32B 27/08; C08F 110/06; C08J 5/00; B29C 47/06

(52) U.S. Cl. 428/516; 526/348; 264/331.17; 264/173.19

(57) ABSTRACT

The present disclosure is directed to a thermoforming process and thermoformed articles produced therefrom. The thermoforming process includes heating a structure with a gloss layer composed of a propylene-based polymer having a melt flow rate from about 0.1 g/10 min to about 1.5 g/10 min, and producing a thermoformed article wherein the gloss layer has a post-thermoformed Gardner gloss value within 25% of the pre-thermoformed Gardner gloss value for the gloss layer. The thermoformed article may have a gloss layer with a post-thermoformed Gardner gloss value greater than or equal to about 60.

### CROSS REFERENCE TO RELATED APPLICATION

This application claims the benefit of U.S. Provisional Application No. 61/237,747 filed on Aug. 28, 2009, the contents of which are herein incorporated by reference in its entirety.

### BACKGROUND

The present disclosure relates to a process for producing a thermoformed article with high gloss retention, and articles produced therefrom.

A thermoforming operation typically changes the gloss of a sheet to be thermoformed. This change sometimes results in an increase in gloss, but more often results in a decrease in gloss for the thermoformed article. Thermoplastics which have high melt strength (i.e., low melt flow rate) have difficulty retaining gloss after thermoforming. Polymer chains within an olefin-based polymer, for example, tend to relax and coil after thermoforming. The gloss retention (i.e., the gloss post-thermoforming) for a high melt strength polyolefin can drop as much as 50% or more compared to the gloss value for the pre-thermoformed polyolefin. A low gloss retention value renders the finished thermoformed article unacceptable for high gloss end use applications. Accordingly, a thermoformed article with high melt strength and high gloss retention would be desired.

### SUMMARY

The present disclosure is directed to a thermoforming process and thermoformed articles produced therefrom. In an embodiment, a process is provided which includes heating a structure to a surface temperature from about 190° C. to less than 230° C. The structure includes a gloss layer comprising a propylene-based polymer. The gloss layer has a pre-thermoformed Gardner gloss value. The process includes thermoforming the structure into a thermoformed article wherein the gloss layer has a post-thermoformed Gardner gloss value within about 25% of the gloss layer pre-thermoformed Gardner gloss value.

The present disclosure provides a thermoformed article. In an embodiment, a thermoformed article is provided which includes a gloss layer composed of a propylene-based polymer with a melt flow rate from about 0.1 g/10 min to about 1.5 g/10 min. The gloss layer has a pre-thermoformed Gardner gloss value greater than or equal to about 80 and a post-thermoformed Gardner gloss value greater than or equal to about 60.

The present disclosure provides another thermoformed article. In an embodiment, a thermoformed article is provided which includes a gloss layer composed of a propylene-based polymer having a melt flow rate from about 0.1 g/10 min to about 1.5 g/10 min. The propylene-based polymer contains greater than about 3.5 wt % units derived from ethylene. The gloss layer has a post-thermoformed Gardner gloss value greater than or equal to about 80.

### BRIEF DESCRIPTION OF THE DRAWINGS

FIG. 1 is a graph showing the pre-/post-thermoforming Gardner gloss values for gloss layers composed of several different propylene-based polymers with varying melt flow rates.

FIG. 2 shows atomic force microscopy images for pre-/post-thermoformed gloss layers A and B of FIG. 1.

FIG. 3 is a graph of gloss layer surface temperature vs. post-thermoforming Gardner gloss value for several embodiments of the present disclosure.

FIG. 4 is a bar graph representation of the data from Table 4.

### DETAILED DESCRIPTION

In an embodiment, a process is provided. The process includes heating a structure to a surface temperature from about 190° C. to less than 230° C. The structure includes a gloss layer. The gloss layer includes a propylene-based polymer with a melt flow rate (MFR) from about 0.1 g/10 min to about 1.5 g/10 min as measured in accordance with ASTM D-1238 2.16 kg, 230° C. The gloss layer has a pre-thermoformed Gardner gloss value. The process includes thermoforming the structure into a thermoformed article so that the gloss layer has a post-thermoformed Gardner gloss value within about 25% of the pre-thermoformed Gardner gloss value for the gloss layer.

As used herein, “Gardner gloss” is a measure of reflectivity for a material at a specified angle. The Gardner gloss is measured in accordance with ASTM D-523 at 60°. The term “pre-thermoformed Gardner gloss value,” is the Gardner gloss value of a material before the material has been subjected to a thermoforming process. The term “post-thermoformed Gardner gloss value,” is the Gardner gloss value of a material after the material has been subjected to a thermoforming process. The pre-thermoformed Gardner gloss value and the post-thermoformed Gardner gloss value are measured in accordance with ASTM D-523 at 60°. In an embodiment, the gloss layer has a post-thermoformed Gardner gloss value within about 25%, or within about 20%, or within about 10%, or within 1% to within 25% of the pre-thermoformed Gardner gloss value for the gloss layer.

As used herein, a “structure” is a thermoformable mono-layer or multi-layer film or a thermoformable mono-layer or multi-layer sheet having at least one layer which is the gloss layer and includes the propylene-based polymer. The multi-layer structure may have the propylene-based polymer in one, some, or all of the layers. The structure is a “thermoformable structure” which is a structure that softens when exposed to heat and returns to substantially its original condition when cooled to room temperature. The present thermoformable structure is distinct from, and does not include, a “thermoset structure” which solidifies or “sets” irreversibly when heated.

In an embodiment, the gloss layer is composed solely of the propylene-based polymer. In other words, the gloss layer may consist of only the propylene-based polymer.

The term, “propylene-based polymer,” as used herein, is a polymer that comprises a majority weight percent polymerized propylene monomer (based on the total amount of polymerizable monomers), and optionally may comprise at least one polymerized comonomer. The propylene-based polymer can be a propylene homopolymer, a propylene/olefin interpolymer, a random propylene/olefin copolymer, a propylene/ethylene copolymer, a coupled propylene-based polymer, a clarified propylene-based polymer, a propylene impact copolymer, and any combination of the foregoing.

The propylene/olefin interpolymer may include propylene copolymerized with one or more olefin monomers. Nonlimiting examples of suitable olefins include ethylene and alpha olefins such as 1-butene, 1-pentene, 1-hexene, 1-octene, 1-nonene, 1-decene, 1-unidecene, 1-dodecene and the like as well as 4-methyl-1-pentene, 4-methyl-1-hexane, 5-methyl-1-hexane, vinylcyclohexane, styrene and the like.

In an embodiment, the propylene-based polymer is a propylene/ethylene copolymer. The propylene/ethylene copolymer may contain from about 1 wt % to about 10 wt % units derived from ethylene. In one embodiment, the propylene/ethylene copolymer contains less than about 3.5 wt %, or about 3.2 wt %, units derived from ethylene. In another embodiment, the propylene-based polymer contains greater than about 3.5 wt %, or greater than 3.5 wt % to about 10 wt %, or from about 5 wt % to about 10 wt %, or about 5.7 wt %, units derived from ethylene.

In an embodiment, the process includes clarifying the propylene-based polymer and forming a clarified propylene-based polymer. A “clarified propylene-based polymer,” is the reaction product of a propylene-based polymer and a clarifying agent. The clarified propylene-based polymer may be prepared before or during the thermoforming process. A “clarifying agent” reduces the haze value (as measured in accordance with ASTM D 1003) of the propylene-based polymer. Thus, a clarified propylene-based polymer has a haze value that is less than the haze value of the random propylene and α-olefin copolymer without the clarifying agent. In an embodiment, the clarified propylene-based polymer has a haze value at least 10% less than the haze value of the pre-clarified propylene-based polymer. In an embodiment, the propylene-based polymer is a clarified propylene/olefin copolymer.

The clarifying agent reduces the size of crystallites, thereby improving the transparency and clarity of articles made from the copolymer. Not wishing to be bound by any particular theory, it is believed that the clarifying agent acts as sites for more ordered and faster polyolefin crystallization during cooling. During the process of crystallization, polymer crystals organize into larger superstructures which are referred to as spherulites. The spherulites are more uniform and are smaller in size than spherulites formed in the absence of the clarifying agent. The reduced spherulite size reduces the possibility for light to be scattered. In this way, the clarifying agent improves the optical opacity of the random propylene/α-olefin copolymer. In an embodiment, the clarified propylene-based polymer has a refractive index of about 1.5044 at 589 nm and a haze measurement of about 8.0% or lower.

Nonlimiting examples of suitable clarifying agents include dibenzylidene sorbitol acetal derivatives such as 1,3-O-2,4-bis(3,4-dimethylbenzylidene)sorbitol, available from Milliken Chemical Spartanburg, S.C. under the trade name Millad® 3988, 1,3-O-2,4-bis(p-methylbenzylidene)sorbitol, also available from Milliken Chemical under the trade name Millad® 3940, sodium 2,2′-methylene-bis-(4,6-di-tert-butylphenyl) phosphate (from Asahi Denka Kogyo K. K., known as NA-11), aluminum bis[2,2′-methylene-bis-(4,6-di-tert-butylphenyl)phosphate](also from Asahi Denka Kogyo K. K., known as NA-21), or other nucleators, particularly those which provide extremely quick crystal formation and/or arrangement. The clarified propylene/α-olefin copolymer may include optional additives such as plasticizers, antistatic agents, antioxidants, stabilizers, acid neutralizers, and ultraviolet absorbers.

In an embodiment, the propylene-based polymer is a clarified random propylene/α-olefin copolymer. A nonlimiting example of a clarified random propylene/α-olefin copolymer is available from The Dow Chemical Company of Midland, Mich. under the designation Dow 6D83K Polypropylene Resin. Dow 6D83K is a Ziegler-Natta catalyzed clarified random propylene/ethylene copolymer and contains about 3 percent, or 3.2 percent, by weight units derived from ethylene and has a melt flow rate of about 1.9 g/10 min. This clarified random propylene/ethylene copolymer exhibits a heat of fusion of approximately 93 Joules/gram, a molecular weight distribution (Mw/Mn) of about 4.5 and a melting point of about 145° C. The properties for Dow 6D83K are provided in Table 1 below.

TABLE 1
Dow 6D83K Physical Properties

| Property | Value | | Test Method |
|---|---|---|---|
| Density | 0.9 | g/cc | ASTM D792 |
| Melt Flow | 1.9 g/10 min | | 230° C.; 2.16 kg; ASTM D1238 |
| Tensile Strength, Yield | 28.3 | MPa | Molded and tested in accordance with ASTM |
| | | | D4101; ASTM D638 |
| Elongation at Yield | 10% | | Molded and tested in accordance with ASTM |
| | | | D4101; ASTM D638 |
| Flexural Modulus | 155 | kpsi | 1% Secant; molded and tested in accordance |
| | | | with ASTM D4101; ASTM D790A |
| Izod Impact, Notched, RT | 5.5 | ft-lb/in | Molded and tested in accordance with ASTM |
| | | | D4101; ASTM D256A |
| Deflection Temperature | 86.1° | C. | Unannealed; molded and tested in accordance |
| at 0.46 MPa (66 psi) | | | with ASTM D4101; ASTM D648 |

The propylene-based polymer with a melt flow rate (MFR) from about 0.1 g/10 min to about 1.5 g/10 min may be a coupled propylene-based polymer. In an embodiment, the process includes coupling the propylene-based polymer to form a coupled propylene-based polymer. The coupling occurs before the structure is subjected to the heating and/or the thermoforming procedures. As used herein, “coupling” or “coupled” is the mechanism or the reaction by which the reactive groups of a coupling agent bond together polymer chains within the propylene-based polymer. The coupling reaction between the propylene-based polymer and the coupling agent yields a reaction product that is a coupled propylene-based polymer. A “coupled propylene-based polymer” is a rheology modified propylene-based polymer resulting from a coupling reaction. Not wishing to be bound by any particular theory, it is believed that the propylene-based polymer contains linear polymer chains. The reactive groups of the coupling agent couple or otherwise bond these linear polymer chains together. This increases the amount of long-chain polymer branching within the propylene-based polymer. This presence of long-chain polymer branching correspondingly increases the melt strength and reduces the melt flow rate (MFR) of the coupled propylene compared to the polymer before coupling.

In an embodiment, the coupling agent is a chemical compound that contains at least two reactive groups that are each capable of forming a carbene or a nitrene group that are capable of inserting into the carbon hydrogen bonds of aliphatic, CH, CH₂, or CH₃ groups, and also aromatic CH groups, of a polymer chain. Nonlimiting examples of chemical compounds that contain reactive groups capable of forming carbene groups include diazo alkanes, geminally-substituted methylene groups, and metallocarbenes. Nonlimiting examples of chemical compounds that contain reactive groups capable of forming nitrene groups, include, but are not limited to, phosphazene azides, sulfonyl azides, formyl azides, and azides. The coupled propylene-based polymer may include from about 50 to about 1000 parts by weight of the coupling agent per one million parts of the propylene-based polymer. All individual values and subranges from 50 to 1000 parts per million are included herein.

Nonlimiting examples of suitable coupling agents include poly(sulfonyl azide), and bis(sulfonyl azide). Nonlimiting examples of poly(sulfonyl azide) include 1,5-pentane bis(sulfonyl azide), 1,8-octane bis(sulfonyl azide), 1,10-decane bis(sulfonyl azide), 1,10-octadecane bis(sulfonyl azide), 1-octyl-2,4,6-benzene tris(sulfonyl azide), 4,4′-diphenyl ether bis(sulfonyl azide), 1,6-bis(4′-sulfonazidophenyl)hexane, 2,7-naphthalene bis(sulfonyl azide), and mixed sulfonyl azides of chlorinated aliphatic hydrocarbons containing an average of from 1 to 8 chlorine atoms and from 2 to 5 sulfonyl azide groups per molecule, and mixtures thereof. Nonlimiting examples of the bis(sulfonyl azide) include oxy-bis(4-sulfonylazidobenzene), 2,7-naphthalene bis(sulfonyl azido), 4,4′-bis(sulfonyl azido)biphenyl, 4,4′-diphenyl ether bis(sulfonyl azide) and bis(4-sulfonyl azidophenyl)methane, and mixtures thereof. In an embodiment, the coupling agent may be 4,4′-diphenyl oxide bis-sulfonyl azide.

Sulfonyl azides are commercially available or are prepared by the reaction of sodium azide with the corresponding sulfonyl chloride, although oxidation of sulfonyl hydrazines with various reagents (nitrous acid, dinitrogen tetroxide, nitrosonium tetrafluoroborate) has been used.

Other types of coupling and/or coupling agents are within the scope of this disclosure. Coupling may be accomplished by way of such nonlimiting examples as silane grafting/moisture coupling, peroxide coupling, free radical coupling and diene coupling. Coupling may also occur by way of graft maleic anhydride/diamine reaction. In addition, electron beam radiation can be used to introduce long-chain branching into the polymeric composition. Any of these procedures can be used to decrease the MFR of the polymeric composition.

In an embodiment, the process includes coupling the propylene-based polymer and forming a coupled propylene-based polymer having a melt flow rate (MFR) from about 0.1 g/10 min to about 1.5 g/10 min, or from about 0.1 g/10 min to about 1.0 g/10 min, or from about 0.5 g/10 min to about 0.75 g/10 min as measured in accordance with ASTM 1238, 2.16 kg at 230° C.

In an embodiment, the process includes clarifying and coupling the propylene-based polymer to form a clarified coupled propylene-based polymer. The coupling and clarifying reactions may occur sequentially or simultaneously. In a further embodiment, the coupling and/or the clarifying reactions occur before the thermoforming procedure.

In an embodiment, the propylene-based polymer is devoid of coupling and has a MFR from about 0.1 g/10 min to about 1.5 g/10 min, or from about 0.1 g/10 min to about 1.0 g/10 min, or from about 0.5 g/10 min to about 0.75 g/10 min. In other words, the propylene-based polymer may be uncoupled and have a MFR from about 0.1 g/10 min to about 1.5 g/10 min.

The present process includes heating the structure to a surface temperature from about from about 190° C. to less than 230° C. and thermoforming the structure into a thermoformed article. As used herein, “thermoforming,” is the process of forming or shaping a thermoplastic structure by heating the structure to a formable state (such as above the softening temperature of the structure) and fitting the formable structure along the contours of a mold. Thermoforming occurs under thermoforming conditions. Similarly, “thermoforming conditions” are temperature and pressure parameters suitable to place the structure in a moldable state. The molded structure is cooled to a non-formable state and removed from the mold yielding a thermoformed article. The term “surface temperature,” as used herein, is the temperature of the structure at the surface thereof. It is understood that the temperature within the heating chamber of a thermoforming apparatus is not necessarily the same as the surface temperature of the structure to be thermoformed. The surface temperature is determined by measuring the surface temperature of the structure (i.e., the surface temperature of the gloss layer and/or the base layer) immediately, or substantially immediately, upon removal from the thermoforming apparatus, by way of an infrared scanning device, for example. Oven temperature may be measured by temperature probes (such as infrared probes and/or thermocoupling) located in the thermoforming apparatus.

In an embodiment, the process includes producing the thermoformed article with a gloss layer having a post-thermoformed Gardner gloss value of greater than or equal to about 60. The post-thermoformed Gardner gloss value is also within about 25% of the pre-thermoformed Gardner gloss value for the gloss layer.

In an embodiment, the gloss layer has a pre-thermoformed Gardner gloss value greater than 80. The process includes forming a thermoformed article having a gloss layer with a post-thermoformed Gardner gloss value greater than or equal to about 80 or from about 80 to about 90.

In an embodiment, the process includes coextruding a base layer to the gloss layer to form a multi-layer structure. The coextrusion occurs before the thermoforming procedure. The gloss layer contains the propylene-based polymer. The propylene-based polymer may be any propylene-based polymer as disclosed herein. The base layer may be a single-component or a multi-component olefin-based polymer such as an ethylene-based polymer, a propylene-based polymer, an impact propylene copolymer, and combinations thereof.

In an embodiment, the base layer is a thermoplastic polyolefin (TPO). As used herein, a “thermoplastic polyolefin” is a polyolefin that is thermoformable. The TPO may be a single component or a blend of two or more components. Nonlimiting examples of suitable TPOs include propylene-based polymers, ethylene-based polymers, and combinations thereof.

In an embodiment, the TPO is a blend and is composed of (i) a coupled impact propylene copolymer and (ii) an elastomer. The impact propylene copolymer may have a density of about 0.900 g/cc and a melt flow rate of about 0.50 g/10 min (230° C./2.16 kg, ASTM 1238). The elastomer may be an ethylene/propylene copolymer with a density of about 0.875 g/cc (ASTM D 792) and a melt flow rate of 2.9 g/10 min (190° C./10 kg, ASTM 1238). A nonlimiting example of a suitable TPO is D500 Developmental Performance Polymer available from The Dow Chemical Company, Midland, Mich. The TPO may or may not include a filler. In an embodiment, the base layer and/or the gloss layer includes a pigment.

In an embodiment, the TPO is a blend of a polypropylene homopolymer, elastomer, and a filler (and optionally a nucleating agent and/or a coupling agent).

In an embodiment, the process includes forming a thermoformed multi-layer article from the multi-layer structure which includes the gloss layer and the base layer. The gloss layer includes the propylene-based polymer. The gloss layer of the thermoformed article has a post-thermoformed Gardner gloss value that is within about 25% of the pre-thermoformed Gardner gloss value for the gloss layer as discussed above.

Heating of the structure may occur for a duration from about 50 seconds to about 400 seconds, or from about 75 seconds to about 300 seconds, or from about 90 seconds to about 200 seconds.

FIG. 1 is a graph showing pre-/post-thermoformed Gardner gloss values for gloss layers composed of propylene-based polymer at varying melt flow rates. The surface temperature during thermoforming is 185° C. FIG. 1 illustrates that as the melt flow rate decreases (i.e., the melt strength of the gloss layer increases), the post-thermoformed Gardner gloss value for the gloss layer decreases. In FIG. 1, Sample A with a MFR of 0.5 g/10 min has a lower post-thermoformed Gardner gloss value than Sample B with a MFR of about 1.9 g/10 min.

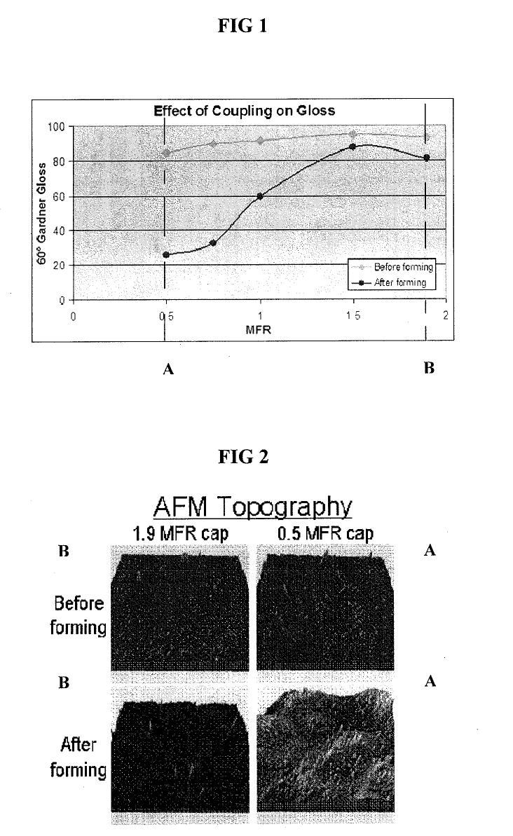

FIG. 2 shows pre-/post-thermoformed atomic force microscopy (AFM) topography images for gloss layers A and B of FIG. 1. Gloss layer B shows little or no change in surface roughness post-thermoforming. Conversely, gloss layer A shows substantial change in surface roughness post-thermoforming. FIG. 2 shows that the surface roughness increases significantly after gloss layer A is thermoformed.

Applicants have surprisingly discovered that post-thermoformed gloss value is influenced by the polymer chain re-surfacing phenomenon that occurs during thermoforming. Not wishing to be bound by any particular theory, it is believed that gloss loss due to thermoforming is the result of the presence of unrelaxed polymer chains on the structure surface. Chain relaxation and chain re-arrangement depends on the chain structure and the molecular weight of the propylene-based polymer. Polymeric chains with branched or high molecular weight molecules require more heating in order to begin rearrangement and also have longer relaxation times. Applicants have surprisingly found that gloss loss can be minimized by controlling polymer chain relaxation and/or polymer chain rearrangement on the structure surface.

Applicants unexpectedly discovered that a surface temperature from about 190° C. to less than 230° C. during thermoforming unexpectedly optimizes chain relaxation and/or chain re-arrangement for propylene-based polymers with a MFR of 0.1 g/10 min to about 1.5 g/10 min. Applicants further discovered that (i) thermoforming at this surface temperature range of 190° C. to less than 230° C. in conjunction with (ii) control of the comonomer content in the propylene-based polymer synergistically operates to further improve polymer chain relaxation time and concomitantly increase post-thermoformed Gardner gloss values for the gloss layer.

Bounded by no particular theory, it is believed that the surface temperature range of 190° C. to less than 230° C. provides sufficient heat to mobilize frozen unrelaxed polymeric chains in propylene-based polymer with 0.1-1.5 g/10 min MFR, enabling larger molecules to re-arrange their space with respect to smaller molecules. A surface temperature below this range is insufficient to mobilize polymeric chains. A surface temperature above this range reduces post-thermoformed Gardner gloss as it creates surface flow which yields greater surface roughness. In addition, it is believed that comonomer content can be adjusted to lower the melting point of the propylene-based polymer and further increase the relaxation time for polymer chains.

In an embodiment, the process includes heating the structure to a surface temperature from about 204° C. to about 215° C., or from about 205° C. to about 214° C. and thermoforming the structure into a thermoformed article. The structure includes a gloss layer (optionally coextruded to a base layer). The gloss layer is composed of a propylene-based polymer with an MFR from about 0.1 g/10 min to about 1.5 g/10 min. The propylene-based polymer also contains greater than about 3.5 wt % units derived from ethylene. Applicants have surprisingly discovered that this surface temperature range of 204° C. to about 215° C. in combination with the comonomer content of greater than 3.5 wt % ethylene unexpectedly produces a thermoformed article with a gloss layer having a post-thermoformed Gardner gloss value greater than or equal to about 80, or from about 80 to about 90. In an embodiment, the gloss layer has a pre-thermoformed Gardner gloss value greater than or equal to about 80.

In an embodiment, the propylene-based polymer is a coupled propylene-based polymer. In a further embodiment, the gloss layer is composed solely of the propylene-based polymer.

In an embodiment, the propylene-based polymer of the thermoformed article includes greater than about 3.5 wt % to about 10 wt %, or about 5.7 wt %, units derived from ethylene.

In an embodiment, the process includes heating the structure to surface temperature from about 190° C. to about 230° C., or from about 190° C. to about 210° C., or from about 204° C. to about 215° C., and thermoforming the structure into a thermoformed article. The structure includes a gloss layer (optionally coextruded to a base layer). The gloss layer is composed of a propylene-based polymer with an MFR from about 0.1 g/10 min to about 1.5 g/10 min. The propylene-based polymer also contains less than about 3.5 wt % units derived from ethylene. Applicants have surprisingly discovered that this surface temperature range of 190° C. to about 210° C. in combination with the comonomer content of less than 3.5 wt % ethylene unexpectedly produces a thermoformed article with a gloss layer having a post-thermoformed Gardner gloss value greater than or equal to about 60, or from about 60 to about 70. In a further embodiment, the propylene-based polymer is a coupled propylene-based polymer.

In an embodiment, the propylene-based polymer is a coupled propylene-based polymer. In a further embodiment, the gloss layer is composed solely of the propylene-based polymer.

In an embodiment, the propylene-based polymer is selected from a coupled propylene-based polymer, a clarified propylene-based polymer, and combinations thereof.

In an embodiment, the thermoformed article includes a base layer coextruded to the gloss layer. The base layer may include any olefin-based polymer and/or elastomer as disclosed herein. In a further embodiment, the base layer includes a TPO.

The gloss layer and/or the base layer may include one or more additives. Nonlimiting examples of suitable additives include processing aids, anti-oxidants, and/or light inhibitors.

The present process may comprise two or more embodiments disclosed herein.

The present disclosure provides an article. In an embodiment, a thermoformed article is provided and includes a gloss layer comprising a propylene-based polymer with a melt flow rate from about 0.1 g/10 min to about 1.5 g/10 min. The gloss layer has a pre-thermoformed Gardner gloss value greater than about 80 and a post-thermoformed Gardner gloss value greater than or equal to about 60, or from about 60 to about 90.

The propylene-based polymer may be any propylene-based polymer disclosed herein. In an embodiment, the propylene-based polymer of the thermoformed article includes greater than about 3.5 wt % units derived from ethylene. The gloss layer has a post-thermoformed Gardner gloss value greater than or equal to about 80, or from about 80 to about 90, or from about 80 to about 85.

In an embodiment, the propylene-based polymer of the thermoformed article includes less than about 3.5 wt %, or about 3.2 wt %, units derived from ethylene. The gloss layer has a post-thermoformed Gardner gloss value from about 60 to about 70.

The present disclosure provides another article. In an embodiment, a thermoformed article is provided and includes a gloss layer comprising a propylene-based polymer comprising (i) greater than about 3.5 wt % units derived from ethylene. The propylene-based polymer has a melt flow rate from about 0.1 g/10 min to about 1.5 g/10 min. The gloss layer has a post-thermoformed Gardner gloss value greater than or equal to 80, or from about 80 to about 90.

The propylene-based polymer may be any propylene-based polymer disclosed herein. In an embodiment, the propylene-based polymer includes from about 5 wt % to about 10 wt %, or about 5.7 wt % units derived from ethylene.

Any of the foregoing thermoformed articles may include a base layer coextruded to the gloss layer. The base layer may be any base layer as disclosed herein.

The propylene-based polymer of the any of the foregoing thermoformed articles may be selected from an uncoupled propylene-based polymer, a coupled propylene-based polymer, clarified propylene-based polymer, and combinations thereof.

Thermoformed article(s) can be any thermoformed article. Nonlimiting examples of suitable thermoformed articles include automotive parts such as fender skirts, covers, trim pieces, housings, and hoods. The thermoformed articles may or may not include a pigment.

The thermoformed article may comprise two or more embodiments disclosed herein.

Nonlimiting embodiments of the process and the thermoformed article are provided below.

In an embodiment a process is provided which includes heating a structure to a surface temperature from about 190° C. to less than 230° C. The structure comprises a gloss layer composed of a propylene-based polymer with a melt flow rate from about 0.1 g/10 min to about 1.5 g/10 min. The process further comprises thermoforming the structure into a thermoformed article and the gloss layer has a post-thermoformed Gardner gloss value within about 25% of the gloss layer pre-thermoformed Gardner gloss value as measured in accordance with ASTM D-523 at 60°.

In an embodiment, the process comprises producing a gloss layer having a post-thermoformed Gardner gloss value greater than or equal to about 60.

In an embodiment, the propylene-based polymer of the gloss layer includes greater than about 3.5 wt % units derived from ethylene. The process comprises heating the structure (i.e., the gloss layer) to a surface temperature from about 204° C. to about 215° C. and producing a gloss layer with a post-thermoformed Gardner gloss value greater than or equal to about 80.

In an embodiment, the propylene-based polymer of the gloss layer includes less than about 3.5 wt % units derived from ethylene. The process comprises heating the structure (i.e., the gloss layer) to a surface temperature from about 190° C. to about 210° C. and producing a gloss layer with a post-thermoformed Gardner gloss value greater than or equal to about 60.

In an embodiment, the process comprises coupling, before the heating, the propylene-based polymer and producing a coupled propylene-based polymer.

In an embodiment, the process comprises heating the structure for a duration from about 75 seconds to about 300 seconds.

In an embodiment, a thermoformed article is provided and comprises a gloss layer comprising a propylene-based polymer. The propylene-based polymer has a melt flow rate from about 0.1 g/10 min to about 1.5 g/10 min. The gloss layer has a pre-thermoformed Gardner gloss value greater than about 80 and a post-thermoformed Gardner gloss value greater than or equal to about 60 as measured in accordance with ASTM D-523 at 60°.

In an embodiment, the propylene-based polymer comprises greater than about 3.5 wt % units derived from ethylene. The gloss layer has a post-thermoformed Gardner gloss value greater than or equal to about 80.

In an embodiment, the propylene-based polymer of the thermoformed article comprises less than about 3.5 wt % units derived from ethylene. The gloss layer has a post-thermoformed Gardner gloss value from about 60 to about 70.

Another article is provided. In an embodiment, a thermoformed article is provided and comprises a gloss layer comprising a propylene-based polymer comprising (i) greater than about 3.5 wt % units derived from ethylene. The propylene-based polymer has a melt flow rate from about 0.1 g/10 min to about 1.5 g/10 min. The gloss layer has a post-thermoformed Gardner gloss value greater than or equal to about 80 as measured in accordance with ASTM D-523 at 60°.

In an embodiment, the propylene-based polymer of the thermoformed article comprises from about 5 wt % to about 10 wt % units derived from ethylene.

In an embodiment, one or both of the thermoformed articles comprises a base layer coextruded to the gloss layer.

In an embodiment, the propylene-based polymer of the thermoformed article is selected from the group consisting of an uncoupled propylene-based polymer, a coupled propylene-based polymer, a clarified propylene-based polymer, and combinations thereof.

### DEFINITIONS

All references to the Periodic Table of the Elements herein shall refer to the Periodic Table of the Elements, published and copyrighted by CRC Press, Inc., 2003. Also, any references to a Group or Groups shall be to the Groups or Groups reflected in this Periodic Table of the Elements using the IUPAC system for numbering groups. Unless stated to the contrary, implicit from the context, or customary in the art, all parts and percents are based on weight. For purposes of United States patent practice, the contents of any patent, patent application, or publication referenced herein are hereby incorporated by reference in their entirety (or the equivalent US version thereof is so incorporated by reference), especially with respect to the disclosure of synthetic techniques, definitions (to the extent not inconsistent with any definitions provided herein) and general knowledge in the art.

The term “comprising,” and derivatives thereof, is not intended to exclude the presence of any additional component, step or procedure, whether or not the same is disclosed herein. In order to avoid any doubt, all compositions claimed herein through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

Any numerical range recited herein, includes all values from the lower value to the upper value, in increments of one unit, provided that there is a separation of at least 2 units between any lower value and any higher value. As an example, if it is stated that the amount of a component, or a value of a compositional or a physical property, such as, for example, amount of a blend component, softening temperature, melt index, etc., is between 1 and 100, it is intended that all individual values, such as, 1, 2, 3, etc., and all subranges, such as, 1 to 20, 55 to 70, 197 to 100, etc., are expressly enumerated in this specification. For values which are less than one, one unit is considered to be 0.0001, 0.001, 0.01 or 0.1, as appropriate. These are only examples of what is specifically intended, and all possible combinations of numerical values between the lowest value and the highest value enumerated, are to be considered to be expressly stated in this application. In other words, any numerical range recited herein includes any value or subrange within the stated range. Numerical ranges have been recited, as discussed herein, reference melt index, melt flow rate, and other properties.

The terms “blend” or “polymer blend,” as used herein, is a blend of two or more polymers. Such a blend may or may not be miscible (not phase separated at molecular level). Such a blend may or may not be phase separated. Such a blend may or may not contain one or more domain configurations, as determined from transmission electron spectroscopy, light scattering, x-ray scattering, and other methods known in the art.

The term “composition,” as used herein, includes a mixture of materials which comprise the composition, as well as reaction products and decomposition products formed from the materials of the composition.

The term “polymer” is a macromolecular compound prepared by reacting (i.e., polymerizing) monomers of the same or different type. “Polymer” includes homopolymers and interpolymers.

The term “interpolymer,” is a polymer prepared by the polymerization of at least two different types of monomers. The generic term interpolymer thus includes copolymers, usually employed to refer to polymers prepared from two different monomers, and polymers prepared from more than two different types of monomers.

The term “olefin-based polymer” is a polymer containing, in polymerized form, a majority weight percent of an olefin, for example ethylene or propylene, based on the total weight of the polymer. Nonlimiting examples of olefin-based polymers include ethylene-based polymers and propylene-based polymers.

The term, “ethylene-based polymer,” as used herein, is a polymer that comprises a majority weight percent polymerized ethylene monomer (based on the total weight of polymerizable monomers), and optionally may comprise at least one polymerized comonomer.

The term, “propylene-based polymer,” as used herein, is a polymer that comprises a majority weight percent polymerized propylene monomer (based on the total amount of polymerizable monomers), and optionally may comprise at least one polymerized comonomer.

The term “alkyl,” as used herein, refers to a branched or unbranched, saturated or unsaturated acyclic hydrocarbon radical. Nonlimiting examples of suitable alkyl radicals include, for example, methyl, ethyl, n-propyl, i-propyl, 2-propenyl (or allyl), vinyl, n-butyl, t-butyl, i-butyl (or 2-methylpropyl), etc. The alkyls have 1 to 20 carbon atoms.

The term “substituted alkyl,” as used herein, refers to an alkyl as just described in which one or more hydrogen atom bound to any carbon of the alkyl is replaced by another group such as a halogen, aryl, substituted aryl, cycloalkyl, substituted cycloalkyl, heterocycloalkyl, substituted heterocycloalkyl, halogen, haloalkyl, hydroxy, amino, phosphido, alkoxy, amino, thio, nitro, and combinations thereof. Suitable substituted alkyls include, for example, benzyl, trifluoromethyl and the like.

The term “aryl,” as used herein, refers to an aromatic substituent which may be a single aromatic ring or multiple aromatic rings which are fused together, linked covalently, or linked to a common group such as a methylene or ethylene moiety. The aromatic ring(s) may include phenyl, naphthyl, anthracenyl, and biphenyl, among others. The aryls have 1 and 20 carbon atoms.

### TEST METHODS

Melt flow rate (MFR) is measured in accordance with ASTM D 1238-01 test method at 230° C. with a 2.16 kg weight for propylene-based polymers.

Structure surface temperature is determined by scanning the structure surface with an infrared temperature gun upon removal of the thermoformed article from the thermoforming apparatus.

By way of example and not by limitation, examples of the present disclosure will now be provided.

### EXAMPLES

### A. Coupled Propylene-Based Polymer

TABLE 2
1. Materials

| | | Units derived | | |
|---|---|---|---|---|
| Resin | | from ethylene | BSA | MFR |
| Sample | Material | (wt %) | coupled | (g/10 min) |
| PP1 | 6D83K | 3.2 | No | 1.9 |
| PP1A | 6D83K (BSA-modified) | 3.2 | Yes | 0.75 |
| PP2 | M | 5.7 | No | 1.4 |
| PP2A | M | 5.7 | Yes | 0.75 |
| PP3 | M | 5.7 | No | 0.7 |
| PP4 | M | 3.8 | No | 0.7 |
| PP5 | M | 3.8 | No | 1.4 |
| PP6 | M | 5.7 | No | 1.4 |

M = clarified propylene/ethylene copolymer reactor resin

2. Sheet Co-Extrusion:

Each of the materials is a gloss layer (or cap layer) in a multi-layer sheet. Each gloss layer is co-extruded with a base layer composed of D500, available from The Dow Chemical Company, Midland, Mich. Coextrusion occurs in a Welex Ultima III system. The gloss layer thickness is 10% to the sheet thickness of 100 mil. The coextrusion conditions are: a melt temperature of 230° C. for both the base layer and the cap layer with an air gap of 4 inches at a line rate of 4 ft/min.

3. Thermoforming:

Thermoforming is performed in a ZMD Thermoformer. This is a straight vacuum forming process with female molds. It has a forming area from 6 inches×6 inches up to 24 inches×36 inches, top platen stroke of 24 inches, bottom platen stroke of 12 inches, access opening of 36 inches, vacuum tank capacity of 30 gals, and total air flow at 35 cfm. As used herein, the “sag rate” is the time (in seconds) it takes for a heated thermoplastic sheet to droop (by way of gravity) a chosen distance. For purposes of this disclosure, the sag rate is based on a 25 inch×35 inch thermoplastic sheet having a thickness of 187 mils, the sheet being heated from ambient at a heat rate of 2.2° F./second. The “chosen distance” is the distance between a first position that is 3.25 inches below the clamp frame of the thermoformer and a second position that is 5.5 inches below the clamp frame. Thus, the “chosen distance” is 2.25 inches. A detection device is located at the first position. The sheet is heated at 2.2° F./second while in the clamp frame. Upon heating, the center of the sheet begins to droop. Once the lowermost portion of the drooping sheet passes a detector at the first position, determination of sag rate commences with initiation of a timer. With continued heating at the heat rate of 2.2° F./second, the sheet continues to droop. The time it takes the lowermost portion of the heated sheet to reach the second position (i.e., 5.5 inches below the clamp frame) is then measured. This is the “travel time.” The sag rate (inches/second) for the sheet is calculated as follows.

Sag rate=2.25 inches/travel time (seconds)

The standard thermoforming cycle time is used which has a cycle time less than 150 seconds in the oven with sag of 30 inches. Various heating zone settings are used to achieve the desired surface temperature. Surface temperature is measured by an IR temperature gun. The standard surface temperature is about 180° C. or lower. As shown in Table 3, increasing the surface temperature during the thermoforming process increases the post-thermoforming Gardner gloss value. Examples 1 and 2 use PP1 and PP1A, respectively, thermoformed under standard thermoforming conditions with a surface temperature of 180° C. PP1 has good post-thermoforming Gardner gloss. PP1A has poor post-thermoforming Gardner gloss. However, PP1A has excellent sag resistance. Examples 6 and 7 use PP2 and PP2A, respectively, thermoformed under standard thermoforming conditions with a surface temperature of 180° C. PP2 has good post-thermoforming Gardner gloss. PP2A has poor post-thermoforming Gardner gloss. However, PP2A has excellent sag resistance. Typically, sag resistance is inversely proportional to the MFR of the resin.

Examples 3 and 4 show excellent post-thermoformed Gardner gloss when the surface temperature of PP1A is between 190° C. and 210° C. In Example 3, PP1A is thermoformed at a surface temperature of 201° C. and exhibits high post-thermoformed Gardner gloss.

Examples 10 to 13 show excellent post-thermoformed Gardner gloss when the surface temperature of PP2A is between 204° C. and 215° C. In Example 10, PP2A is thermoformed at a surface temperature of 206° C. and exhibits high post-thermoformed Gardner gloss.

Table 3 below provides a summary of the results.

TABLE 3

| | Examples | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| PP | PP1 | PP1A | PP1A | PP1A | PP1A | PP2 | PP2A | PP2A | PP2A | PP2A | PP2A | PP3 | PP2A |
| MFR (g/10 min) | 1.9 | 0.75 | 0.75 | 0.75 | 0.75 | 1.4 | 0.75 | 0.75 | 0.75 | 0.75 | 0.75 | 0.75 | 0.75 |
| % C2 | 3.2 | 3.2 | 3.2 | 3.2 | 3.2 | 5.7 | 5.7 | 5.7 | 5.7 | 5.7 | 5.7 | 5.7 | 5.7 |
| Surface | 180 | 180 | 201 | 205 | 215 | 180 | 180 | 185 | 201 | 206 | 207 | 210 | 214 |
| temp(° C.) | | | | | | | | | | | | | |
| Pre-thermoform | 78.5 | 78.7 | 76.9 | 79.7 | 70.9 | 92 | 87.6 | 89.1 | 89.1 | 87.9 | 88.8 | 87.5 | 87.9 |
| Gardner gloss | | | | | | | | | | | | | |
| Post-thermoform | 80.2 | 31.6 | 68.1 | 61.9 | 28.0 | 86 | 23.8 | 22.9 | 32.6 | 82.7 | 81.4 | 78.7 | 79.6 |
| Gardner gloss | | | | | | | | | | | | | |

*Each Example in Table 3 is a coextruded structure including (i) a 0.1 inch thick base layer of D500 and (ii) a 0.01 inch thick gloss layer of the stated PP1-PP6

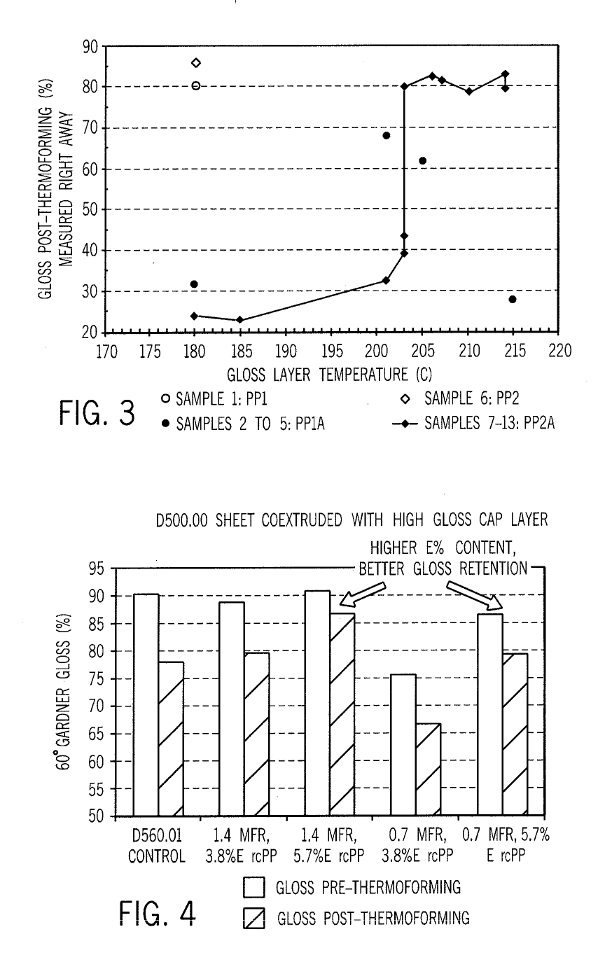

FIG. 3 is a graph showing the gloss layer surface temperature vs. the post-thermoforming Gardner gloss values for examples 1-13 of Table 3.

### B. Uncoupled Propylene-Based Polymer

Table 4 illustrates the affect of comonomer content on the post-thermoformed Gardner gloss layer for the gloss layer at a constant thermoforming surface temperature of 185° C. As the wt % of ethylene increases, the post-thermoformed Gardner gloss increases, regardless of the MFR for the resin.

TABLE 4

| | Gardner Gloss (Pre-) | | | Gardner Gloss (Post-) | | |
|---|---|---|---|---|---|---|
| | | Sheet | | | Sheet | |
| Examples** | Top | Edge | Overall | Top | Edge | Overall |
| Gloss Layer | (Center) | (Side) | Avg. | (Center) | (Side) | Avg. |
| D560.01 Control | 92 | 89 | 90 | 77 | 79 | 78 |
| 1.9 MFR, 3.8% E rcPP | | | | | | |
| Example 14 | 86 | 87 | 87 | 77 | 82 | 79 |
| PP3 - 0.7 MFR, 5.7% E rcPP | | | | | | |
| Example 15 | 72 | 79 | 76 | 59 | 74 | 67 |
| PP4 - 0.7 MFR, 3.8% E rcPP | | | | | | |
| Example 16 | 89 | 88 | 89 | 77 | 82 | 80 |
| PP5 - 1.4 MFR, 3.8% E rcPP | | | | | | |
| Example 17 | 92 | 90 | 91 | 86 | 88 | 87 |
| PP6 - 1.4 MFR, 5.7% E rcPP | | | | | | |

**Each Example in Table 4 is a coextruded structure including (i) a 0.18 inch thick base layer of D500 and (ii) a 0.02 inch thick gloss layer of the stated PP14-PP17.
% E = wt % units derived from ethylene
rcPP = random propylene copolymer - control, and PP14-PP17 each are uncoupled random propylene/ethylene copolymer

FIG. 4 is a bar graph representation of the average pre-/post-thermoforming Gardner gloss values for the gloss layers of Table 4.

It is specifically intended that the present disclosure not be limited to the embodiments and illustrations contained herein, but include modified forms of those embodiments including portions of the embodiments and combinations of elements of different embodiments as come within the scope of the following claims.

We claim:

1. A process comprising:
heating a structure to a surface temperature from about 190° C. to less than 230° C., the structure comprising a gloss layer comprising a propylene-based polymer with a melt flow rate from about 0.1 g/10 min to about 1.5 g/10 min as measured in accordance with ASTM D-1238; and
thermoforming the structure into a thermoformed article, the gloss layer having a post-thermoformed Gardner gloss value within about 25% of the gloss layer pre-thermoformed Gardner gloss value as measured in accordance with ASTM D-523 at 60°.

2. The process of claim 1 comprising producing a gloss layer having a post-thermoformed Gardner gloss value greater than or equal to about 60.

3. The process of claim 1 wherein the propylene-based polymer comprises greater than about 3.5 wt % units derived from ethylene, the process comprising heating the structure to a surface temperature from about 204° C. to about 215° C. and producing a gloss layer with a post-thermoformed Gardner gloss value greater than or equal to about 80.

4. The process of claim 1 wherein the propylene-based polymer comprises less than about 3.5 wt % units derived from ethylene, the process comprising heating the structure to a surface temperature from about 190° C. to about 210° C. and producing a gloss layer with a post-thermoformed Gardner gloss value greater than or equal to about 60.

5. The process of claim 1 comprising coextruding to the gloss layer a base layer comprising a thermoplastic polyolefin; and
forming a multi-layer structure.

6. A thermoformed article comprising:
a gloss layer comprising a propylene-based polymer with a melt flow rate from about 0.1 g/10 min to about 1.5 g/10 min as measured in accordance with ASTM D-1238 2.16 kg, 230° C., the gloss layer having a pre-thermoformed Gardner gloss value greater than or equal to about 80 and a post-thermoformed Gardner gloss value greater than or equal to about 60 as measured in accordance with ASTM D-523 at 60°.

7. The thermoformed article of claim 6 wherein the propylene-based polymer comprises greater than about 3.5 wt % units derived from ethylene and the gloss layer has a post-thermoformed Gardner gloss value greater than or equal to about 80.

8. The thermoformed article of claim 6 wherein the propylene-based polymer comprises less than about 3.5 wt % units derived from ethylene and the gloss layer has a post-thermoformed Gardner gloss value from about 60 to about 70.

9. The thermoformed article of claim 6 wherein the propylene-based polymer is a clarified propylene-based polymer.

10. The thermoformed article of claim 6 wherein the propylene-based polymer is a coupled propylene-based polymer.

11. The thermoformed article of claim 6 wherein the propylene-based polymer is a clarified coupled propylene-based polymer.

12. The thermoformed article of claim 6 comprising a base layer comprising a thermoplastic polyolefin coextruded to the gloss layer.

13. The thermoformed article of claim 12 wherein the base layer comprises a coupled impact propylene copolymer and an elastomer.

14. The thermoformed article of claim 12 wherein the base layer comprises a blend of a propylene homopolymer, an elastomer, and a filler.

15. A thermoformed article comprising:
a gloss layer comprising a propylene-based polymer comprising (i) greater than about 3.5 wt % units derived from ethylene and (ii) a melt flow rate from about 0.1 g/10 min to about 1.5 g/10 min as measured in accordance with ASTM D-1238 2.16 kg, 230° C., the layer having a post-thermoformed Gardner gloss value greater than or equal to about 80 as measured in accordance with ASTM D-523 at 60°.

16. The thermoformed article of claim 15 wherein the propylene-based polymer comprises about 5 wt % to about 10 wt % units derived from ethylene.

17. The thermoformed article of claim 15 wherein the propylene-based polymer is selected from the group consisting of a clarified propylene-based polymer, a coupled propylene-based polymer, and combinations thereof.

18. The thermoformed article of any of claims 15 comprising a base layer coextruded to the gloss layer.

19. The thermoformed article of claim 18 wherein the base layer comprises a coupled impact propylene copolymer and an elastomer.

20. The thermoformed article of claim 18 wherein the base layer comprises a blend of a propylene homopolymer, an elastomer, and a filler.
